(19) United States
(12) Patent Application Publication
(10) Pub. No.: US 2008/0299489 A1
(43) Pub. Date: Dec. 4, 2008

(54) ULTRAVIOLET CURABLE COATING FLUID FOR PRINTING SYSTEMS

(76) Inventor: Gary W. Byers, San Diego, CA (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 11/757,627

(22) Filed: Jun. 4, 2007

(51) Int. Cl. G03C 1/00; G03C 5/00

(52) U.S. Cl. 430/286.1; 430/328

(57) ABSTRACT

An ultraviolet curable coating fluid includes a polymerizable olefin monomer or monomer blend that undergoes self-photoinitiating polymerization when exposed to a predetermined ultraviolet wavelength range, and a predetermined amount of an ultraviolet absorbing image stabilizer that has minimal absorption in the predetermined ultraviolet wavelength range.

### BACKGROUND

The present disclosure relates generally to coating fluids, and more particularly to an ultraviolet curable coating fluid for printing systems.

Ultraviolet (UV) curable clear/colorless overcoat compositions may be applied over a printed image on a substrate to form a protective, durable overcoat layer thereon. Generally, UV curable overcoat compositions include monomers that tend to rapidly polymerize, in the presence of an ultraviolet light absorbing “photoinitiator,” under irradiation of an active energy source (e.g., UV light). It is believed that this rapid polymerization continues from a point of initiation until a chain termination reaction (such as oxygen scavenging) stops the polymerization reaction. Termination processes limit the molecular weight of the polymer chains and the extent of cure.

Poor cure in the depth of a coating may lead to cohesive failures and/or loss of adhesion to a support. The efficiency of the initiation process and the cure near the bottom of a coating may be undesirably attenuated, at least in part because the UV excitation intensity decreases with depth of penetration. The decrease in UV excitation intensity may result from light absorption by photoinitiators, UV absorbing photoinitiator degradation products, and/or the presence of other UV absorbing chromophores.

Clear/colorless overcoat compositions may also be formulated to protect colorants and/or polymers that may be damaged by ambient UV light. Such colorants and/or polymers may be present in images and/or substrates. These overcoat compositions may include a UV light absorbing stabilizer to protect the image or surface from transmitted UV light. In some instances, however, UV absorbing stabilizers present in amounts sufficient to provide suitable protection may exacerbate the formulation cure problem and militate curing to the bottom of such a coating.

### BRIEF DESCRIPTION OF THE DRAWINGS

Features and advantages of embodiments of the present disclosure will become apparent by reference to the following detailed description and drawings.

FIG. 1 is a graph depicting the molar extinction of TINUVIN® 328 (Ciba Specialty Chemicals) in ethanol; and

FIG. 2 is a graph depicting the transmission spectra (% absorbed) of UV cured coatings both with and without TINUVIN® 328.

### DETAILED DESCRIPTION

Embodiment(s) of the coating fluid disclosed herein advantageously include a self-photoinitiating olefin monomer or blend of olefin monomers and at least one 2-(2-hydroxyphenyl)-benzotriazole (also referred to herein as “benzotriazole”) class UV absorbing image stabilizer. It is believed that by curing at a wavelength where the self-photoinitiating olefin monomer/monomer blend absorbs strongly and the benzotriazole image stabilizer absorbs minimally, the coating fluid is capable of curing through to the substrate, thereby yielding enhanced adhesion and enhanced ambient UV protection of the image, substrate and/or overcoat. Furthermore, the coating fluid efficiently cures under relatively high energy UV-C irradiation (with wavelengths ranging approximately from 230 nm to 280 nm) without the use of additional photoinitiators. It is believed that since no photoinitiator is added, the penetration of cure light is facilitated during cure. It is further believed that since conventional residual photoinitiator degradation products are absent, the continued generation of radicals after curing is substantially reduced or eliminated.

The coating fluid may advantageously be used in a variety of applications in which a protective coating is desirable. In one embodiment, the coating fluid is applied over a printed image on the substrate via a suitable printing technique. Generally, the printed image having the coating fluid applied thereon exhibits enhanced lightfastness toward UV light, and one or more improvements in ozone resistance, gloss, optical density, chroma, dry smudge resistance, and wet smudge resistance.

In an embodiment, the coating fluid includes a polymerizable olefin monomer (e.g., an electron deficient olefin monomer) or a polymerizable olefin monomer blend (including an electron rich olefin monomer and an electron deficient monomer believed to yield a UV absorbing charge transfer (C-T) complex) that undergoes self-photoinitiating polymerization within a predetermined UV-C wavelength range (about 230 nm to about 280 nm), and a predetermined amount of a benzotriazole image stabilizer that has minimal absorption in the predetermined UV-C wavelength range.

In some embodiments, the olefin monomer/monomer blend and the benzotriazole image stabilizer are dissolved in a vehicle (discussed further hereinbelow). Inclusion of the vehicle may depend, at least in part, on the printing system used to deposit the coating fluid. For example, volatile components and/or a particular viscosity may be desirable to discharge drops of the coating fluid when using thermal inkjet (TIJ) or other inkjet printing applications. As such, the addition of a vehicle (e.g., solvent, surfactant, etc.) may be desirable to add such volatile components and/or to achieve such a viscosity. In other embodiments however, the selected printing system is capable of depositing the coating fluid without the addition of a vehicle to the fluid. As a non-limiting example, some piezoelectric printing systems are able to print embodiments of the coating fluid including olefin monomers selected to have an adequate viscosity for such a printing system.

It is believed that a vehicle may impact charge transfer (C-T) olefin monomer complex formation of the electron deficient—electron rich olefins. This may be due, at least in part to the vehicle changing the association constant(s) and/or the olefin monomer concentrations. As such, in embodiments including a vehicle, it is to be understood that the vehicle is selected such that at least 1) charge transfer (C-T) olefin monomer complexes are allowed to form prior to and/or during curing, and 2) any deleterious effect on the fraction of olefin present as the C-T olefin monomer complex is minimized. In an embodiment, ethanol is a suitable solvent, in part because it evaporates prior to exposure to a curing lamp, thereby reducing the risk of bubble and/or vent formation.

In some embodiments, the coating fluid includes an electron deficient olefin monomer without an electron rich olefin monomer. One non-limiting example of such an electron deficient monomer includes N-substituted maleimides. Without being bound to any theory, it is believed that these monomer olefins possess strong active absorptions in the UV range and contribute to effective UV curing without having to introduce photoinitiators into the coating fluid formulation to initiate polymerization.

In other embodiments, the coating fluid includes a monomer blend including an electron rich olefin monomer and an electron deficient olefin monomer. The olefin monomer blend used in the coating fluid is believed to form the charge transfer complex between electron rich and electron deficient olefin monomers. Without being bound to any theory, it is believed that these charge transfer monomer olefin complexes possess strong active absorptions in the UV range and contribute to effective UV curing without having to introduce photoinitiators into the coating fluid formulation to initiate polymerization. The olefin monomer complex photoinitiates via a charge transfer transition that bleaches its charge transfer UV absorption as the olefin monomers polymerize. This process produces a substantially clear and/or colorless overcoat that is capable of improving image durability. As used herein, the term “substantially clear and/or colorless” means that the coating fluid is transparent, is without color, and/or is slightly colored but does not deleteriously affect the characteristics (e.g., color) of the underlying image.

In an embodiment, the charge transfer olefin monomer complex includes a mixture of at least one electron-rich olefin monomer and at least one electron-deficient olefin monomer. In an embodiment, the electron-rich and electron-deficient olefin monomers are formulated to have a 1:1 equivalent stoichiometry (i.e., an equal number of electron rich and electron deficient polymerizable olefin moieties) in the coating fluid formulation. It is believed that the 1:1 olefin monomer complex has the UV-C absorption transition that initiates polymerization. It is further believed that the maximum absorption (amount of complex) is increased by pushing the stoichiometry toward 1:1 and increasing the concentration of complexing olefins.

It is to be understood that the stoichiometry of the olefin monomers may deviate from 1:1, as long as the C-T complex competes effectively for cure UV-C light. Effective competing is a function of, at least in part, the nature of the complex (i.e., the olefins selected affect the absorption), the association constant and concentration of monomers (the actual concentration/coverage of the C-T complex), the amount of UV stabilizer used, the presence of other competing UV absorbing species, the thickness of the coating, and/or combinations thereof. Generally, the further the olefin monomer stoichiometry is from 1:1, the lower the total amount of complex formed, and the lower the C-T absorption.

It is to be understood that any desirable number of different electron-rich and/or electron-deficient olefin monomers may be used. For example, the complex may include two different electron-rich olefin monomers and one electron-deficient olefin monomer. In an embodiment when different electron-rich or electron-deficient monomers are selected, it is to be understood that the stoichiometric ratio of electron-rich olefin monomers to electron-deficient olefin monomers may still be about 1:1 (equivalence).

Examples of the electron-rich olefin monomer(s) include, but are not limited to vinyl ethers, such as diethyleneglycoldivinyl ether and 4-hydroxybutylvinyl ether, N-vinyl amides, such as N-vinylcaprolactam and N-vinyl-2-pyrrolidinone, and/or combinations thereof. The structures of such electron-rich olefin monomers are shown below, which, in an embodiment, exclude R group moieties having strong UV-C absorptions at 230 to 285 nm, such as aromatic phenyl rings.

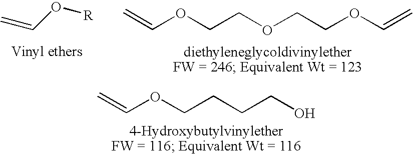

It is to be understood that vinyl ethers have a tendency to hydrolyze in the presence of a wet and slightly acidic environment. As such, it may be desirable to maintain the vinyl ethers in a slightly alkaline environment.

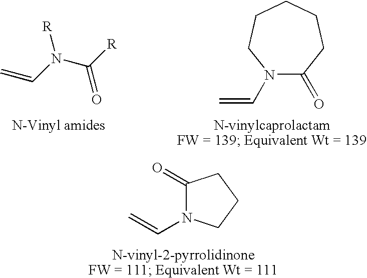

Examples of the electron-deficient monomer include N-substituted maleimide molecules, which include single maleimides (such as N-(2-hydroxyethyl)maleimide) and multiple maleimides (such as 1,6-hexamethylenedimaleimide). The structures of such electron-deficient monomers are shown below.

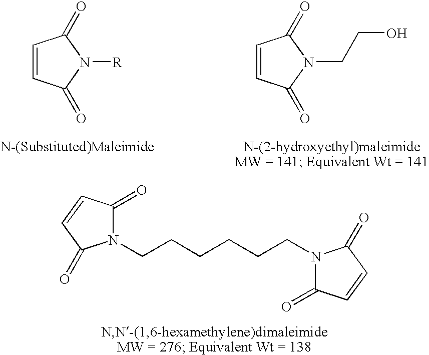

Bifunctional/polyfunctional olefin monomers such as diethyleneglycoldivinylether and N,N′-(1,6-hexamethylene)dimaleimide provide cross linking sites, which enhance the polymer molecular weight.

To reduce fading of an image or substrate caused by exposure to ambient UV light, a UV absorbing image stabilizer is used in the coating fluid formulation. It is believed that the image stabilizer contributes to such fade reduction by absorbing ambient UV light (which is dominated by light having wavelengths ranging from about 290 nm to about 400 nm) such that printed images (having the coating fluid thereon) are not deleteriously affected by exposure thereto. As disclosed herein, the 2-(2-hydroxyphenyl)-benzotriazole image stabilizer used in the coating fluid formulation is generally colorless, and has minimal UV-C absorption at the wavelength range (about 240 nm to 260 nm) where there is minimal or no ambient UV light and where the self-photoinitiating olefin monomer/monomer complex cures efficiently. As such, it is believed that the benzotriazole UV absorbing image stabilizers, although potentially absorbing some cure photons, have a relatively minimal adverse impact upon the curing process, and enhance the ambient UV light fade resistance of the printed image. It is further believed that the durability of the printed image is not deleteriously impacted by the minimal window of transmission (i.e., near 240 nm-260 nm), at least in part, because there is extremely little ambient light at wavelengths around 250 nm, where the self-photoinitiating olefin monomer/monomer complex efficiently cures.

As previously mentioned, the self-photoinitiating olefin monomer/monomer complex cure efficiently when exposed to light wavelengths within the window of transmission of the 2-(2-hydroxyphenyl)-benzotriazole stabilizers, i.e., from about 240 nm to about 260 nm. As such, a benzotriazole image stabilizer having minimal absorption within that wavelength range is selected for the coating formulation. The phrase “minimal absorption,” as used herein, means that the amount of light absorption that occurs within the particular wavelength range is relatively small, such that at useful, but modest, stabilizer amounts, competing light absorption does not substantially interfere with curing processes accomplished within the particular wavelength range.

Non-limiting examples of the 2-(2-hydroxyphenyl)-benzotriazole image stabilizer used in the coating fluid are those having maximum absorption capabilities at wavelengths greater than about 300 nm and less than or equal to about 400 nm. The benzotriazole class of stabilizers also has minimal absorption in the UV-C wavelength range of 240 nm to 260 nm. Suitable 2-(2-hydroxyphenyl)-benzotriazole stabilizers include those that are commercially available from Ciba Specialty Chemicals, Tarrytown, N.Y. Such materials tend to be oil-soluble materials. In a non-limiting example, the benzotriazole stabilizer is TINUVIN® 328 (Ciba Specialty Chemicals).

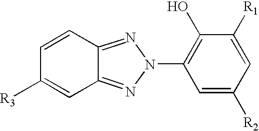

### 2-(2-HydroxyPhenyl)-Benzotriazole UV Absorbing Stabilizer Class (Preferred R has minimal UV-C absorption)

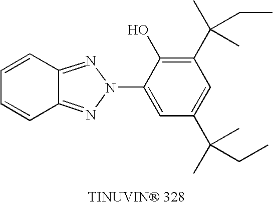

The stabilizer, despite having minimal absorption in the 240 nm to 260 nm range, competes for UV-C cure light. As such, stabilizer loading should be minimized to facilitate depth of cure, but should also be sufficient to provide image protection. The image protection provided in a coating may be described in terms of stabilizer coverage in units of moles/1000 cm². Generally, the weight per unit area of benzotriazole UV absorbing stabilizer determines, at least in part, the UV transmission contributions of the stabilizer, and independently, the weight per unit area of monomer olefins determines the thickness of the polymer coating. Thus, the actual benzotriazole UV stabilizer loading in the formulation depends upon, at least in part, the anticipated thickness of the applied coating and the fraction of incident UV light that may be tolerated.

Generally, stabilizer coverage (moles/1000 cm²) that will yield desired transmission optical densities (ODs) may be estimated using the solution (e.g., 95% ethanol) extinction coefficient (ε=18400 at 343 nm; coverage=OD/ε). The calculation indicates that about 5.4×10⁻⁵ moles/1000 cm² of benzotriazole stabilizer is desirable per unit of transmission OD at 343 nm, OD₃₄₃. For TINUVIN® 328 (FW 327), the calculated results include a) 8.9 mg/1000 cm² estimated for 0.5 OD₃₄₃ (about 70% of incident 343 nm UV absorbed), b) 17.8 mg/1000 cm² estimated for 1.0 OD₃₄₃ (about 90% of incident 343 nm UV absorbed), and c) 26.7 mg/1000 cm² estimated for 1.5 OD₃₄₃ (about 97% of incident 343 nm UV absorbed). It is to be understood that additional or less coverage may be desirable, depending, at least in part, on the application (e.g., for outdoor applications, additional coverage may be desirable to allow for fade of the stabilizer).

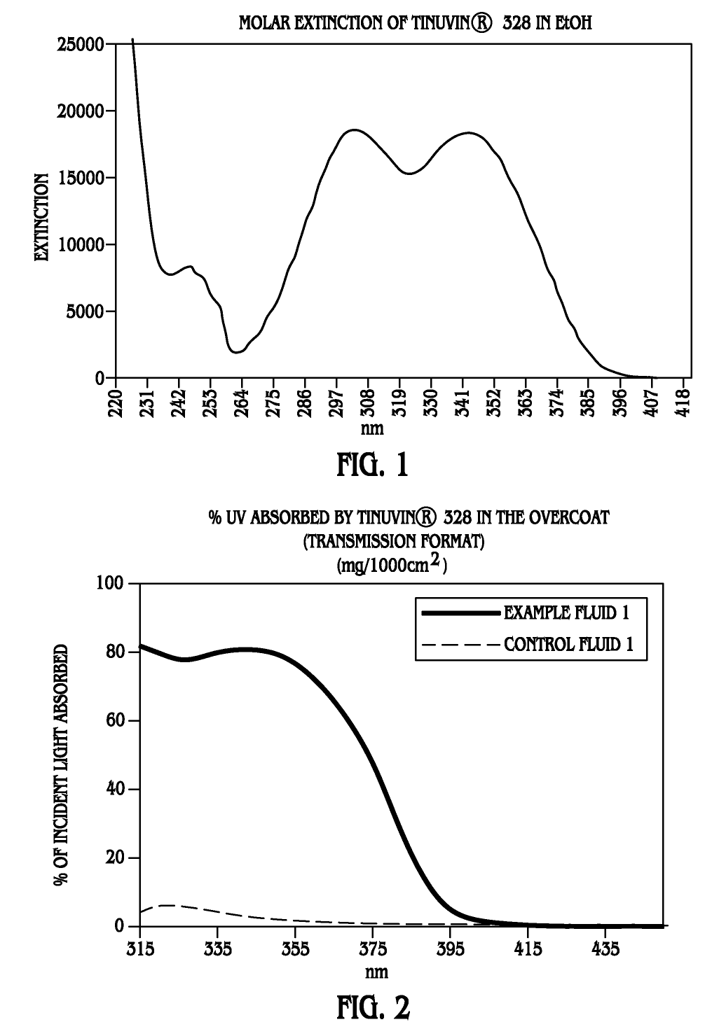

Referring now to FIG. 1, a graph of the UV absorption curve of TINUVIN® 328 in ethanol is depicted. The molar extinction of the stabilizer tracks with transmission optical density (OD), and OD is the negative log of the fraction of light transmitted. As such, the OD increases directly as the stabilizer coverage increases. As one non-limiting example, if stabilizer coverage is adequate to yield an OD (at 342 nm) of 1.0 (10% light transmitted to the bottom of the coating; ε about 18400), an expected UV-C OD (at 263 nm) is about 0.11 (78% light transmitted; ε about 2000). As another non-limiting example, if stabilizer coverage is adequate to yield an OD₃₄₂ of 2.0 (1% light transmitted), the OD₂₆₃ will be about 0.22 (about 60% light transmitted). As still another non-limiting example, if stabilizer coverage is adequate to yield an OD₃₄₂ of 3.0 (0.1% light transmitted), the OD₂₆₃ will be about 0.33, (about 47% light transmitted). As such, the amount of stabilizer varies both the UV curing and the image protection.

As previously mentioned, to facilitate application of the coating in certain printing systems, the olefin monomer/monomer complex and the image stabilizer may be added to the vehicle. As defined herein, a “vehicle” refers to the combination of water and/or solvents (and additives, if desired) to which the olefin monomer/monomer complex and image stabilizer may be added. Suitable additives may include, but are not limited to non-nucleophilic modestly volatile co-solvents, surfactants, polymers, buffers, biocides, sequestering agents, viscosity modifiers, surface-active agents, and/or mixtures thereof. At least in part to avoid chemical degradation of the olefin reagents, some chemicals and/or conditions may be excluded from the vehicle. For example, nucleophiles (such as amines and halogen ions) are potential “Michael Addition” reagents that may degrade the electron deficient maleimide olefins. As another example, under non-anhydrous conditions, acidic components may lead to “eneol ether hydrolysis” of the vinyl ether electron rich olefins. In an embodiment, the formulation is maintained at a very slight alkaline pH with minimal exposure to nucleophiles (such as strong bases/hydroxide ions, halogen ions, and amines). In an embodiment, the vehicle for the coating fluid includes a surfactant and a solvent.

The vehicle may include one solvent or a combination of two or more solvents. Generally, the solvents and/or co-solvents are selected such that they evaporate from the deposited coating prior to curing. As previously stated, the commercially available image stabilizers from Ciba tend to be oil-soluble, and thus they may be incompatible with some systems (e.g., aqueous ink inkjet printers) used to produce the printed images upon which the coating fluid is established. As such, the coating fluid vehicle solvent(s) is/are selected to facilitate deposition through thermal inkjet printers, piezoelectric inkjet printers, or other printers or application strategies. Non-limiting examples of suitable solvents include ethanol, methanol, isopropanol, 2-methyl-2-propanol, ethyl acetate, and/or the like, and/or combinations thereof. It is believed that such solvents are capable of being removed prior to curing, thereby reducing the risk of bubbles, voids and/or permanent defects generating in the coating during the UV curing step. In an embodiment, the solvent(s) are present in the coating fluid formulation in an amount ranging from about 0 wt % to about 50 wt %.

The surfactant(s) may be used in the vehicle to assist in controlling the physical properties of the coating fluid, such as surface tension/wetting, jetting stability, waterproofness, and bleeding. In an embodiment, the surfactant(s) may be ionic or nonionic, as long as it is non-nucleophilic. Suitable non-limiting examples of nonionic surfactants include ethoxylated alcohols such as those from the TERGITOL® series (e.g., TERGITOL ® 15S5, TERGITOL ® 15S7), manufactured by Union Carbide, Houston, Tex.; surfactants from the SURFYNOL® series (e.g. SURFYNOL ® 440 and SURFYNOL ® 465), manufactured by Air Products and Chemicals, Inc., Allentown, Pa.; fluorinated surfactants, such as those from the ZONYL® family (e.g., ZONYL® FSO and ZONYL® FSN surfactants), manufactured by E. I. duPont de Nemours Company, Wilmington, Del.; and fluorinated POLYFOX® nonionic surfactants (e.g., PG-154 nonionic surfactants), manufactured by Omnova, Fairlawn, Ohio. Non-limiting examples of suitable ionic surfactants include surfactants of the DOWFAX® family (e.g., DOWFAX® 8390, DOWFAX® 2A1), manufactured by Dow Chemical Company, Midland, Mich.; anionic ZONYL® surfactants (e.g., ZONYL® FSA), manufactured by E. I. duPont de Nemours Company or combinations thereof. In an embodiment, the amount of surfactant present in the coating fluid ranges from about 0.15 wt % to about 0.25 wt %.

Additives may also be incorporated into the vehicle. As used herein, the term “additives” refers to constituents of the fluid that operate to enhance performance, environmental effects, aesthetic effects, or other similar properties of the coating fluid. Examples of additives include biocides, sequestering agents, chelating agents, corrosion inhibitors, or the like, or combinations thereof.

An embodiment of the method of using the coating formulation includes printing the coating fluid on at least a portion of an image formed on a substrate, and curing the coating fluid by exposing it to light within the previously described wavelength range (i.e., the wavelength range at which the olefin monomer complex self-photoinitiates and cures).

In an embodiment, the image is formed by establishing ink on a substrate via printing techniques. Inkjet printing is one non-limiting example of such a technique. As used herein, the term “inkjet printing” refers to non-impact methods for producing images and/or coating layers by the deposition of ink and/or coating fluid droplets in a pixel-by-pixel manner onto an image-recording medium (i.e., a substrate) in response to appropriate commands, such as digital signals. Non-limiting examples of suitable inkjet printing techniques include piezoelectric inkjet printing, thermal inkjet printing, and/or combinations thereof. It is to be understood that other suitable deposition techniques may also be used to form the image and/or establish the coating fluid. Examples of such deposition techniques include gravure printing, other techniques capable of forming a substantially continuous coating, or the like, or combinations thereof.

In an embodiment, the ink used to form the printed image may be a pigment-based ink, a dye-based ink, or combinations thereof, as the coating fluid may be compatible with both. The type and amount of ink established depends, at least in part, on the formulation of the coating fluid, the size, shape, and/or configuration of the image to be formed, and/or the desirable color of the image to be formed. In an embodiment, the images produced by the inks include alphanumeric indicia, graphical indicia, or combinations thereof.

The coating fluid may then be printed or otherwise established on the dried image. Suitable methods for printing the coating fluid include, but are not limited to piezoelectric inkjet printing, thermal inkjet printing, gravure printing, and/or combinations thereof.

Various methods may be employed to control the deposition of the coating fluid droplets on the substrate. In embodiments described hereinabove, a vehicle may be added to the olefin monomer blend/complex and stabilizer to facilitate ease of printing. It is further believed that the hydrophilic or hydrophobic properties of the coating fluid may be altered in order to enhance the compatibility of the coating with a particular image printing system. In an embodiment, the coating fluid may be formulated using modestly volatile often hydrophilic materials and may be used for thermal inkjet printing, or the coating fluid may be formulated with hydrophobic materials and may be used for piezoelectric inkjet printing.

Curing the established coating fluid is accomplished by exposing the coating fluid to high energy ultraviolet radiation having a large portion of the energy distribution within the wavelength range of about 240 nm to about 260 nm. Without being bound to any theory, and as previously discussed, it is believed that since the stabilizer exhibits minimal absorption, and the olefin monomer/monomer complex (i.e., the cure initiator) exhibits high absorption within the given wavelength range, upon exposure to such radiation, the olefin monomers/monomer complexes are polymerized/consumed, thereby a) entraining the stabilizer, b) facilitating light penetration through to the substrate surface, and c) facilitating thorough cure. This results in enhanced cohesion within the coating layer and enhanced adhesion to the surface, in part because curing is accomplished through to the substrate surface.

Since the coating fluid may be established via inkjet printing, it is to be understood that the coating fluid may be used in a printing system. The printing system includes an inkjet printer, an inkjet ink, and the coating fluid. The printed ink forms the printed image, and the cured coating fluid forms a clear, relatively glossy overcoat on the printed image.

In an embodiment, the substrate is selected from coated papers, glossy photopapers, semi-gloss photopapers, heavy weight matte papers, billboard papers, vinyl papers, nonporous papers, high gloss polymeric films, and/or transparencies. Plain and porous papers may also be used, however, the coating fluid may, in some instances, more readily penetrate such papers (compared to coated papers) prior to curing.

To further illustrate embodiment(s) of the present disclosure, examples are given herein. It is to be understood that these examples are provided for illustrative purposes and are not to be construed as limiting the scope of the disclosed embodiment(s).

### EXAMPLE 1

Two coating fluids including a 1:1 ratio of electron-deficient monomers to electron-rich monomers were prepared. The coating fluids were diluted with alcohol to enhance the compatibility with a thermal inkjet printing system. One of the coating fluids (“Example Fluid 1”) included TINUVIN® 328 (Ciba) and the other coating fluid (“Control Fluid 1”) did not include TINUVIN® 328 (Ciba).

The general formula of the coating fluids is shown in Table 1 below. The coating fluid formulation included about 32 wt % N-(2-hydroxyethyl)maleimide (about 2.27 Molal (moles/Kg), which represents 2.27 equivalents e-deficient moiety/Kg), about 2.7 wt % 4-hydroxybutylvinyl ether (about 0.23 Molal, which represents about 0.23 equivalents e-rich moiety/Kg), about 25.2 wt % tetraethyleneglycoldivinyl ether (about 1.02 Molal, which represents about 2.05 equivalents e-rich moiety/Kg), about 0.2 wt % nonionic surfactant, and either 0% or about 1.5 wt % TINUVIN® 328 benzotriazole image stabilizer. The balance (about 40 wt %) of each of the coating fluids was 95% ethanol, which was made slightly alkaline using a trace of NaOH. Ethanol was selected, at least in part, to facilitate thermal inkjet ejection and deposit (see Table 1). These fluids included 2.27 equivalents of both electron-deficient monomers and electron-rich monomers.

TABLE I
Thermal Ink Jet Deliverable UV Curable Overcoat Fluid Formulations

| Components | | % in Fluid |
|---|---|---|
| (2-HOEthyl)Maleimide* | (Eq Wt 141; 2.27 Eq/L) | 32.01 |
| 4-HydroxyButylVinyl Ether* | (Eq Wt 116; 0.23 Eq/L) | 2.64 |
| TetraEthyleneGlycolDiVinyl | (Eq Wt 123; 2.04 Eq/L) | 25.13 |
| Ether* | | |
| ZONYL ® FSN | | 0.21 |
| TINUVIN ® 328 | | 0 (Control |
| | | Fluid 1) or 1.5 |
| | | (Example |
| | | Fluid 1) |
| 95% Ethanol** | | Make up |
| | | (about 40) |

*e-rich and e-deficient olefins formulated at 1:1 stoichiometry
**Ethanol made slightly alkaline (pH about 8 with glass electrode) using a trace of NaOH

Control Fluid 1 and Example Fluid 1 were printed in four passes (4×10 picoliter drops/pixel at 300 pixels/inch for each pen) on clear polyester supports. Control Fluid 1 (without stabilizer) was printed with 2 pens (about 1000 mg Control Fluid 1/1000 cm², or 600 mg curables/1000 cm². Example Fluid 1 (including TINUVIN® 328) was printed with 2 Control Fluid 1 pens in front of 2 Example Fluid 1 (1.5% TINUVIN® 328) pens. The total coverage was estimated at about 1000 mg Control Fluid 1/1000 cm² under 1000 mg Example Fluid 1/1000 cm² for a total coverage of about 2000 mg/1000 cm² (or 1200 mg curables/1000 cm², about twice as thick curable material as in Control Fluid 1). The coverage of TINUVINE® 328 UV absorber was expected to be about 15 mg/1000 cm² (4.5×10⁻⁵moles/1000 cm²).

After the ethanol solvent had largely evaporated (via exposure to the ambient for a few minutes), the coatings were cured at 15′/minute with a FUSION 450 UV lamp station (Fusion UV Systems, Inc.) fitted with an “H” lamp with dichroic reflectors. Both Control Fluid 1 and Example Fluid 1 cured to clear durable glossy overcoats. The “H” lamp has especially high output in the 250-260 nm wavelength region. The cure doses in the UV-C (250-260 nm) band for these examples were about 0.1 J/cm².

FIG. 2 illustrates the % UV light absorption contribution by entrained TINUVIN® 328 in the cured Example Fluid 1, as captured with a CARY 400 UV/Vis spectrometer (VARIAN). The base line for the uncoated clear support was set to 0.00 %. The dashed line (near the baseline) represents the Control Fluid 1 coating on the support without added UV stabilizer. The solid line represents the absorption of the Example Fluid 1 coating. The results shown in FIG. 2 were consistent with the calculated coverage using the solution extinction coefficient (described hereinabove).

The presence of the Example Fluid 1 coating (containing TINUVIN® 328 stabilizer) represents a reduction of over 80% in the UV light (at 343 nm) that reaches the substrate. UV cure of this coating totaling about 1200 mg/1000 cm² curable material was accomplished despite the presence of a useful level of TINUVIN® 328 UV absorbing stabilizer.

### EXAMPLE 2

Control Fluid 1 and Example Fluid 1 were deposited on HP DESIGNJET 2500 magenta pigmented ink images formed on i) vinyl, ii) gelatin subbed resin coated (RC) paper, iii) calendared paper, and iv) porous plain paper. The overcoats were UV cured. The physical durability characteristics and the light fade impact of the coatings were evaluated and compared.

The HP DESIGNJET 2500 magenta pigment image was selected to provide small but measurable UV light fade vulnerability. Image tone scales were printed, using HP DESIGNJET 2500 magenta ink and 18 pL/drop thermal inkjet pens, on vinyl paper (polyvinyl chloride), gelatin subbed resin coated (RC) paper, calendared paper, and porous plain paper. After drying, the printed tone scales were over printed with a curable overcoat using Control Fluid 1 and Example Fluid 1 (see Example 1), but with coverage as described in Table II (below). The vinyl and calendared samples received an overcoat of 600 mg/1000 cm² of Control Fluid 1 followed immediately (milliseconds) by an overcoat of 600 mg/1000 cm² of Example Fluid 1. The RC paper and the porous plain paper samples received overcoats of 600 mg/1000 cm² of Example Fluid 1 (Table II).

Upon drying of the ethanol, the overcoats cured into protective glossy overcoats with the exception of the porous plain paper sample. On the porous plain paper, the formulation was visually observed to penetrate the paper before the ethanol dried and the samples could be cured. It is believed that the relatively rapid penetration of formulation on this porous paper precluded formation of the protective cured overcoat.

The samples were submitted to a 1 year simulated (Xenon arc) sun light behind soda (window) glass, and were evaluated (see Table II). The Example Fluid lovercoats provided significant improvements in the “simulated day light” fade. The porous plain paper sample did not form a protective film, and thus did not show significant improvement in fade.

TABLE II
HP Designjet 2500 Magenta Pigment Ink Image Light Fades* with
Control Fluid 1 Overcoats or Example Fluid 1 Overcoats
Est. Deposits mg/1000 cm²

| | | | | % Loss | |
|---|---|---|---|---|---|
| | Glossy | Cur- | TINUVIN ® | from 0.5 | Dry |
| Media | Overcoat** | ables | 328 | OD*** | Rub**** |
| Vinyl Paper | No | — | — | 10 | 1 |
| Vinyl Paper | Yes | 1200 | 15 | 2 | 5 |
| RC Paper | No | — | — | 9 | 2 |
| RC Paper | Yes | 600 | 15 | 3 | N/A |
| Calendared | No | — | — | 8 | 1.5 |
| Paper | | | | | |
| Calendared | Yes | 1200 | 15 | 3 | 5 |
| Paper | | | | | |
| Porous Plain | No | — | — | 6 | 5 |
| Paper | | | | | |
| Porous Plain | No/Coating | 600 | 15 | 6 | 5 |
| Paper | pen- | | | | |
| | etrated***** | | | | |

*Simulated 1 year sun light behind soda glass
**Visually apparent overcoat-2 pens (est. 600 mg/1000 cm²) and 4 pens (est. 1200 mg/1000 cm²)
***Interpolated (between bracketing density steps) % losses from 0.5 Status A reflection OD
****Qualitative “Dry Rub” using latex finger cot - samples tested immediately after UV cure; 1-5 scale with 1 being unacceptable resistance to dry rub, 3 being average resistance to dry rub, and 5 being excellent resistance to dry rub
*****Very rapid penetration of the porous media precluded surface film (overcoat) formation

### EXAMPLE 3

Control Fluid 1 and Example Fluid 1 (see Example 1 above) were deposited on cyan dye-based ink images (No. 57 color print cartridge; HP part # 6657A) formed on Advanced HP Photo Paper. The overcoats were UV cured, and the light fade impact of the coatings were compared.

A cyan dye image was selected to provide cool white fluorescent light fade vulnerability. Image tone scales were printed, using the cyan ink and 18 pL/drop thermal inkjet pens, on Advanced HP Photo Paper. After drying, the printed tone scales were over printed using Control Fluid 1 and Example Fluid 1 (see Example 1), but with coverage as described in Table III (below). The total overcoat coverage was maintained at about 1200 mg of curable components/1000 cm², with Example Fluid 1 (including TINUVIN® 328) coverages anticipated at 7.5, 15, and 22.5 mg/1000 cm² (see Table III). Upon drying of the ethanol, the Example Fluid 1 overcoats cured into glossy overcoats.

The samples were submitted to 5.3 years simulated office (cool white fluorescence) exposure and evaluated for light fade (see Table III). The overcoats containing increasing levels of TINUVIN® 328 (Example Fluid 1) provided improvements in the “simulated office” fade (see Table III).

TABLE III
Light Fade of Cyan Dye-Based Ink on Modified Advanced HP Photo
Paper Simulated 5.3 Years Office Cool White Fluorescent*
Est. Deposits mg/1000 cm²

| | Glossy | | TINUVIN ® | % Cyan Loss |
|---|---|---|---|---|
| Media | Overcoat** | Curables | 328 | from 0.5 OD*** |
| Photo Paper | No | 0 | 0 | 40 |
| Photo Paper | Yes | 1200 | 7.5 | 21 |
| Photo Paper | Yes | 1200 | 15 | 17 |
| Photo Paper | Yes | 1200 | 22.5 | 16 |

*Fadometer Cool White Fluorescent simulation of 12 hr days at 450Lux
**Overcoat non-volatile curables in ethanol deposited on imaged paper using thermal ink jet and UV cured.
***Losses interpolated (between density steps bracketing 0.5 Status A reflection density)

While several embodiments have been described in detail, it will be apparent to those skilled in the art that the disclosed embodiments may be modified. Therefore, the foregoing description is to be considered exemplary rather than limiting.

What is claimed is:

1. An ultraviolet curable coating fluid, comprising:
a polymerizable olefin monomer or monomer blend that undergoes self-photoinitiating polymerization when exposed to a predetermined ultraviolet wavelength range; and
a predetermined amount of an ultraviolet absorbing image stabilizer that has minimal absorption in the predetermined ultraviolet wavelength range.

2. The coating fluid as defined in claim 1 wherein the image stabilizer is a 2-(2-hydroxyphenyl)-benzotriazole class ultraviolet absorbing image stabilizer.

3. The coating fluid as defined in claim 1 wherein the polymerizable olefin monomer is an N-substituted maleimide.

4. The coating fluid as defined in claim 1 wherein the olefin monomer blend forms a charge transfer monomer olefin complex.

5. The coating fluid as defined in claim 1 wherein the olefin monomer blend includes a mixture of at least one electron rich olefin monomer and at least one electron deficient olefin monomer.

6. The coating fluid as defined in claim 5 wherein the at least one electron rich olefin monomer is selected from 4-hydroxybutylvinyl ether, diethyleneglycoldivinyl ether, N-vinylcaprolactam, N-vinyl-2-pyrrolidinone, and combinations thereof; and wherein the at least one electron deficient olefin monomer is N-(2-hydroxyethyl)maleimide, N,N′-(1,6-hexamethylene)dimaleimide, or combinations thereof.

7. The coating fluid as defined in claim 5 wherein the mixture has 1:1 stoichiometry of the at least one electron rich olefin monomer and the at least one electron deficient olefin monomer.

8. The coating fluid as defined in claim 1 wherein the predetermined ultraviolet wavelength range ranges from about 230 nm to about 280 nm.

9. The coating fluid as defined in claim 1 wherein the olefin monomer blend includes a blend of maleimide derivative monomers and vinyl ether derivative monomers, and wherein the olefin monomer blend is present in an amount ranging from about 60 wt % to about 99.5 wt %.

10. The coating fluid as defined in claim 9, further comprising a vehicle including from about 0 wt % to about 40 wt % solvent and from about 0 wt % to about 0.25 wt % surfactant.

11. The coating fluid as defined in claim 1, further comprising a vehicle.

12. A method of using the coating fluid as defined in claim 1, the method comprising:
printing the coating fluid on an at least a portion of an ink established on a substrate; and
exposing the coating fluid to light within the predetermined ultraviolet wavelength range.

13. The method as defined in claim 12 wherein printing is accomplished via piezoelectric inkjet printing, thermal inkjet printing, gravure printing, or combinations thereof.

14. The method as defined in claim 12 wherein the coating fluid is capable of curing without the addition of photoinitiators when exposed to the light within the predetermined ultraviolet wavelength range.

15. The method as defined in claim 12, further comprising substantially evaporating any solvent in the coating fluid prior to exposing the coating fluid to light within the predetermined ultraviolet wavelength range.

16. A method of making an ultraviolet curable coating fluid, the method comprising:
providing a polymerizable olefin monomer or a blend of polymerizable olefin monomers that undergoes self-photoinitiating polymerization when exposed to a predetermined ultraviolet wavelength range; and
adding, to the monomer or monomer blend, a predetermined amount of an ultraviolet absorbing image stabilizer that has minimal absorption in the predetermined ultraviolet wavelength range.

17. The method as defined in claim 16 wherein the image stabilizer is a 2-(2-hydroxyphenyl)-benzotriazole class ultraviolet absorbing image stabilizer.

18. The method as defined in claim 16, further comprising adding a vehicle to the monomer or monomer blend.

19. The method as defined in claim 18 wherein the vehicle includes at least one of a surfactant, a solvent, or combinations thereof.

20. The method as defined in claim 16 wherein the olefin monomer blend includes maleimide derivative monomers and vinyl ether derivative monomers, wherein the blend is present in the ultraviolet curable coating fluid in an amount ranging from about 60 wt % to about 99.5 wt %, wherein the benzotriazole class ultraviolet absorbing image stabilizer is present in the ultraviolet curable coating fluid in an amount ranging from about 0.5 wt % to about 5.0 wt %, and wherein the method further comprising adding a vehicle including from about 0 wt % to about 40 wt % solvent and from about 0 wt % to about 0.25 wt % surfactant.

21. The method as defined in claim 16, further comprising forming the blend of olefin monomers by mixing together at least one electron rich olefin monomer selected from 4-hydroxybutylvinyl ether, diethyleneglycoldivinyl ether, N-vinylcaprolactam, N-vinyl-2-pyrrolidinone, and combinations thereof, and at least one electron deficient olefin monomer selected from N-(2-hydroxyethyl)maleimide, N,N′-(1,6-hexamethylene)dimaleimide, and combinations thereof.

22. A printing system, comprising:
an inkjet printer;
an inkjet ink printable via the inkjet printer; and
an ultraviolet curable coating fluid printable via the inkjet printer, the ultraviolet curable coating fluid including:
a polymerizable olefin monomer or monomer blend that undergoes self-photoinitiating polymerization when exposed to a predetermined ultraviolet wavelength range; and
a predetermined amount of an ultraviolet absorbing image stabilizer that has minimal absorption in the predetermined ultraviolet wavelength range.

23. The printing system as defined in claim 22 wherein the image stabilizer is a 2-(2-hydroxyphenyl)-benzotriazole class ultraviolet absorbing image stabilizer.
